(19) United States
(12) Patent Application Publication
(10) Pub. No.: US 2022/0308810 A1
(43) Pub. Date: Sep. 29, 2022

(54) IMAGE FORMING APPARATUS AND METHOD OF CONTROLLING AN IMAGE FORMING APPARATUS

(71) Applicant: TOSHIBA TEC KABUSHIKI KAISHA, Tokyo (JP)

(72) Inventor: Shiro MIZOTA, Mishima Shizuoka (JP)

(21) Appl. No.: 17/549,790

(22) Filed: Dec. 13, 2021

(30) Foreign Application Priority Data
Mar. 24, 2021 (JP) 2021-050538

(51) Int. Cl. G06F 3/12

(52) U.S. Cl. CPC G06F 3/1243; G06F 3/1222; G06F 3/1238

(57) ABSTRACT

According to an embodiment, an image forming apparatus reads an application sheet and generates image data indicating an image of the read application sheet. The image forming apparatus transmits the generated image data to an approval apparatus and receives response data from the approval apparatus. The image forming apparatus outputs an approved application sheet if it is determined that application contents described in the application sheet are approved on the basis of the response data.

### CROSS-REFERENCE TO RELATED APPLICATIONS

This application is based upon and claims the benefit of priority from the prior Japanese Patent Application No. 2021-050538, filed on Mar. 24, 2021, the entire contents of which are incorporated herein by reference.

### FIELD

An embodiment described herein generally relates to an image forming apparatus and a method of controlling an image forming apparatus.

### BACKGROUND

Remote working such as teleworking becomes prevalent rapidly. Even in such a work mode, employees may be forced to come to the office in order to put a seal, affix a seal, or sign, which have been conventionally performed.

### BRIEF DESCRIPTION OF THE DRAWINGS

FIG. 1 is a diagram showing an exemplary overall configuration of an approval system including an image forming apparatus according to an embodiment.

FIG. 2 is an external view showing an exemplary overall configuration of the image forming apparatus according to the embodiment.

FIG. 3 is a block diagram showing the image forming apparatus according to the embodiment.

FIG. 4A is a diagram showing an exemplary pre-approval application form according to the embodiment.

FIG. 4B is a diagram showing an exemplary approved application form according to the embodiment.

FIG. 5A is a diagram showing an exemplary screen displayed on a display according to the embodiment.

FIG. 5B is a diagram showing an exemplary screen displayed on the display according to the embodiment.

FIG. 5C is a diagram showing an exemplary screen displayed on the display according to the embodiment.

FIG. 5D is a diagram showing an exemplary screen displayed on the display according to the embodiment.

FIG. 5E is a diagram showing an exemplary screen displayed on the display according to the embodiment.

FIG. 6A is a diagram showing an exemplary screen displayed on an approval apparatus according to the embodiment.

FIG. 6B is a diagram showing an exemplary screen displayed on the approval apparatus according to the embodiment.

FIG. 7 is a flowchart showing the flow of processing of the image forming apparatus 100 according to the embodiment.

### DETAILED DESCRIPTION

According to one embodiment, an image forming apparatus outputs an approved application sheet for an application sheet of an applicant, application contents that need an approval of an approver being described in the application sheet, the approved application sheet indicating that the approver has approved the application contents. The image forming apparatus includes a communication interface, an image reading device, a printer device, and a controller. The communication interface transmits and receives data to and from one or more approval apparatuses to be operated by the approver to approve the application contents described in the application sheet. The image reading device reads the application sheet. The printer device prints out the approved application sheet. The controller causes the image reading device to read the application sheet and generate image data indicating the read application sheet. The controller transmits the generated image data to one approval apparatus of the one or more approval apparatuses via the communication interface. The controller receives response data for the transmitted image data from the one approval apparatus via the communication interface. The controller determines whether or not the application contents described in the application sheet are approved on the basis of the response data. Further, the controller causes the printer device to print out the approved application sheet for the application sheet if it is determined that the application contents described in the application sheet are approved.

In the image forming apparatus according to the embodiment, it is possible to provide an image forming apparatus and a method of controlling an image forming apparatus that are suitable for remote working. Hereinafter, the image forming apparatus according to the embodiment will be described in detail with reference to the drawings. The same reference symbols in the drawings will denote the same or similar portions.

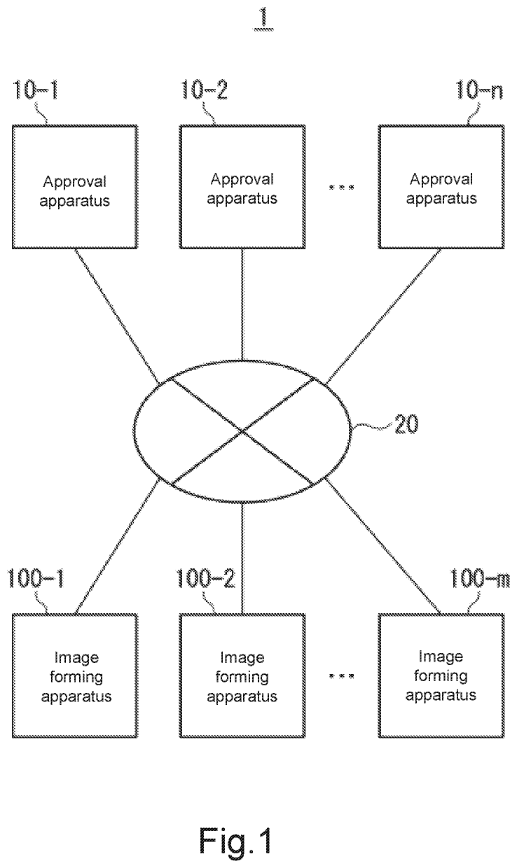

FIG. 1 is a diagram showing an exemplary overall configuration of an approval system 1 including an image forming apparatus 100 according to an embodiment. The approval system 1 shown in FIG. 1 includes m pieces of image forming apparatuses 100-1, . . . , and 100-m, n pieces of approval apparatuses 10-1, . . . , and 10-n, and a network 20 connecting them to each other. If the image forming apparatuses 100-1, . . . , and 100-m are not particularly distinguished from each other hereinafter, any one of them is referred to as an image forming apparatus 100. If the approval apparatuses 10-1, . . . , and 10-n are not particularly distinguished from each other, any one of them is referred to as an approval apparatus 10.

The image forming apparatus 100 is operated by a person (hereinafter, also referred to as “applicant”) who applies to an approver for the approval of application contents 503, which are described in an application sheet to be described later. The image forming apparatus 100 is provided in a remote working place (e.g., employee's home, branch office, etc.). The approval apparatus 10 is an information processing apparatus used by the approver. In other words, the approval apparatus 10 receives an operation of the approver to approve the application contents 503 described in the application sheet to be described later. The approval apparatus 10 is provided in a company or in the remote working place described above. For example, a personal computer (PC), a smart phone, or the like is used as the information processing apparatus.

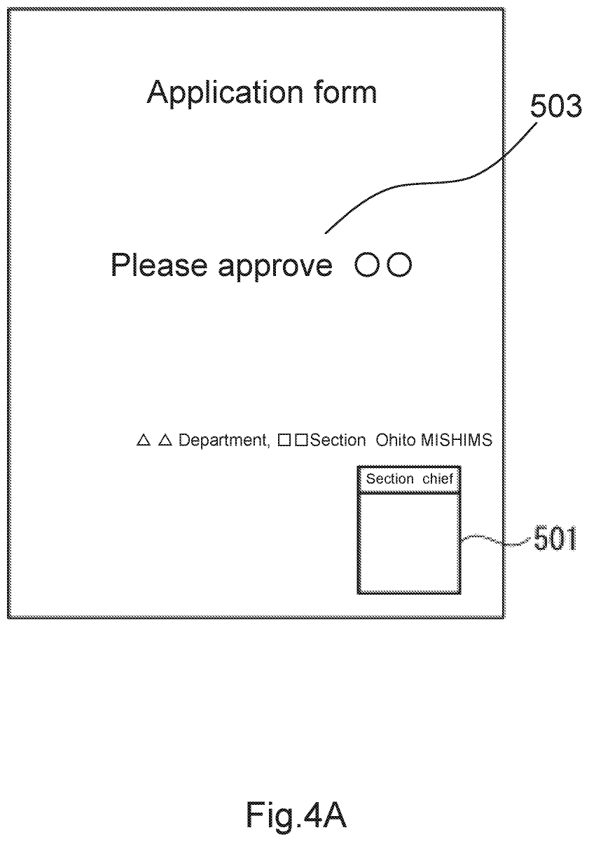

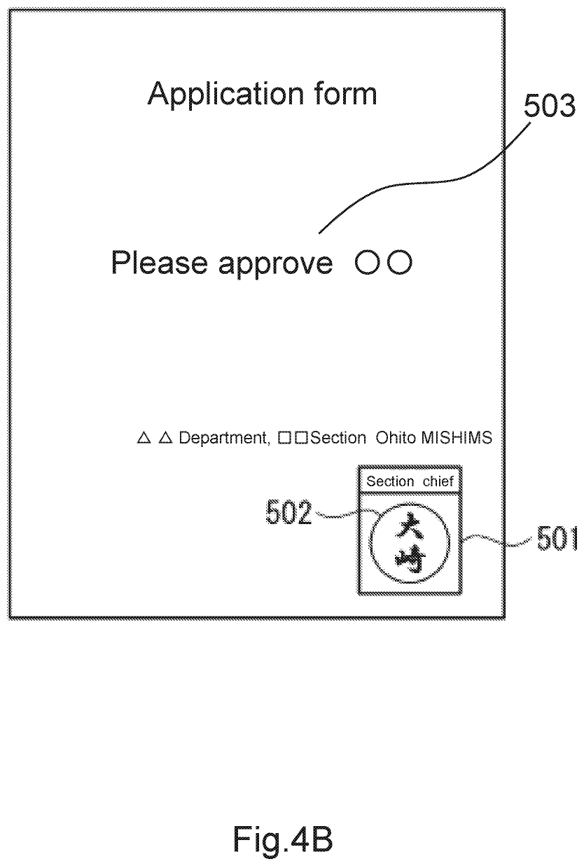

In the approval system 1, the applicant causes the image forming apparatus 100 to read an application sheet (e.g., pre-approval application form shown in FIG. 4A) in which the application contents 503 are described so as to apply to the approver for the approval. The image forming apparatus 100 reads the application sheet and generates application image data indicating the application sheet. The image forming apparatus 100 receives an applicant's designation of an approval destination (approval apparatus or approver who operates the approval apparatus) to which the generated application image data is to be transmitted. Here, any approval apparatus 10 shown in FIG. 1 is designated. The application image data is transmitted to the designated destination (designated approval apparatus 10).

The image forming apparatus 100 determines whether or not the application contents 503 described in the application sheet are approved at the approval destination. If it is determined that the application contents 503 described in the application sheet are approved at the approval destination, the image forming apparatus 100 outputs an approved application sheet (e.g., approved application form shown in FIG. 4B) indicating that the application contents 503 described in the application sheet are approved.

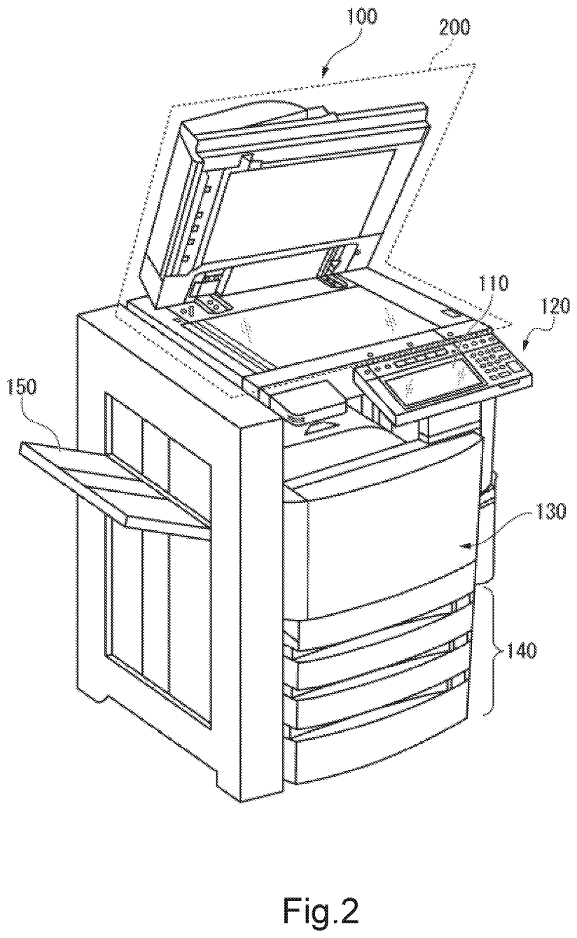

FIG. 2 is an external view showing an exemplary overall configuration of the image forming apparatus 100 according to the embodiment. The image forming apparatus 100 is, for example, a multifunctional machine. The image forming apparatus 100 includes a control panel 120, a printer device 130, a sheet storing device 140, and an image reading device 200.

The image forming apparatus 100 forms an image on a sheet using a developer such as a toner. The sheet is, for example, paper. Any sheet may be used as long as the image forming apparatus 100 can form an image thereon.

The control panel 120 includes a plurality of buttons and a display 110. The control panel 120 receives an operation of a user (applicant). The control panel 120 outputs a signal corresponding to the operation performed by the user to a central processing unit (CPU) of the image forming apparatus 100.

The display 110 is an image display device such as a liquid crystal display or an organic electroluminescence (EL) display. The display 110 displays various types of information regarding the image forming apparatus 100.

The printer device 130 forms an image on a sheet on the basis of the image data generated by the image reading device 200 or the image data received via a communication path. The printer device 130 forms an image by the following processing, for example. The printer device 130 includes an image forming device, a transfer device, and a fixing device. The image forming device forms an electrostatic latent image on a photosensitive drum on the basis of the image data. The image forming device forms a visible image (toner image) on the photosensitive drum by attaching a toner as the developer to the electrostatic latent image. The transfer device transfers the toner image formed on the photosensitive drum onto the sheet. The fixing device fixes the toner image onto the sheet by applying heat and pressure to the sheet. Note that the sheet on which an image is to be formed may be a sheet stored in the sheet storing device 140 or may be a sheet manually fed. The printer device 130 is an exemplary output unit.

The sheet storing device 140 stores sheets to be used for forming images in the printer device 130. A manual feed tray 150 handles not only sheets that can be stored in the sheet storing device 140 but also sheets that cannot be stored in the sheet storing device 140, for example, special sheets such as cardboards. The image reading device 200 generates image data indicating a read document image by moving a colony collapse disorder (CCD) line sensor (not shown) in a sub-scanning direction. The image reading device 200 is an example of a generation unit.

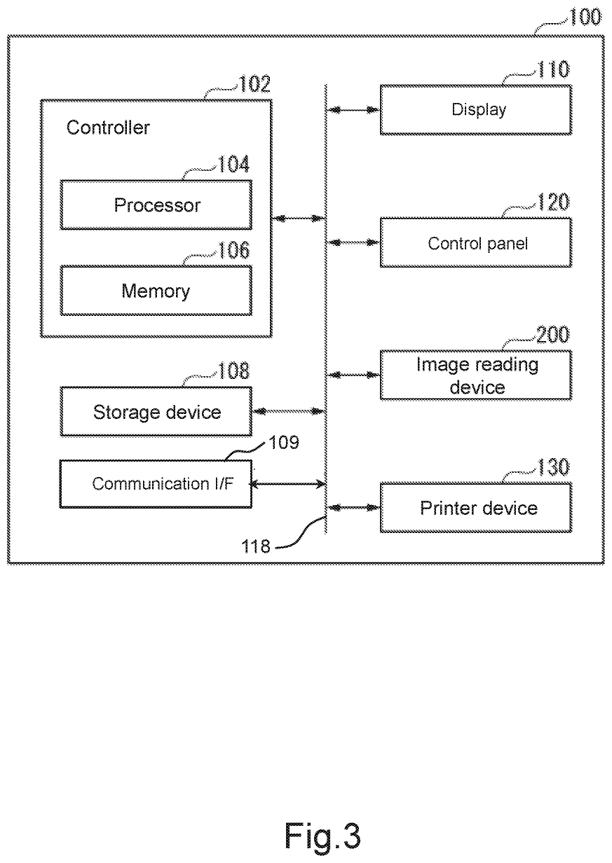

FIG. 3 is a block diagram showing the image forming apparatus 100. The image forming apparatus 100 includes a controller 102, a storage device 108, and a communication interface (I/F) 109. Further, the image forming apparatus 100 includes the control panel 120, the image reading device 200, and the printer device 130 for printing images. The components of the image forming apparatus 100 are connected to each other via a bus 118.

The controller 102 includes a processor 104 and a memory 106. The processor 104 includes a central processing unit (CPU) or a micro processing unit (MPU). The memory 106 includes a read only memory (ROM) and a random access memory (RAM). A control program or the like is stored in the ROM. The RAM provides a temporary work area to the processor 104.

The controller 102 controls each unit on the basis of various programs stored in the ROM or the storage device 108. For example, the controller 102 controls the control panel 120, the image reading device 200, and the printer device 130. The controller 102 is an example of a designation unit and a determination unit.

The storage device 108 stores various programs and the operating system (OS). The various programs include programs for executing functions of the image forming apparatus 100. Examples of the functions of the image forming apparatus 100 include a copying function, a printing function, a scanner function, a facsimile function, and a network file function.

The storage device 108 includes at least one or more of a magnetic storage device, an optical storage device, and a semiconductor storage device. The storage device 108 temporarily stores image data of a document read by the image reading device 200, image data acquired via the communication I/F 109, and the like. For example, the storage device 108 stores application image data indicating an application sheet read by the image reading device 200.

The size (print size) of a sheet on which an image indicated by the image data is to be printed is determined in advance. For example, for the image data of a document read by the image reading device 200, the same size as the size of the read document is determined in advance as the print size. For the image data acquired by the image forming apparatus 100 via the communication I/F 109, the print size is designated by a transmission source such as a PC that transmits the image data.

The communication I/F 109 is an interface that is connected to an external device such as the approval apparatus 10. The communication I/F 109 is connected to an external device in a wireless or wired manner. Examples of wireless or wired standards include Bluetooth (registered trademark), IEEE802.15, IEEE802.11, IEEE802.3, and IEEE1284. The communication I/F 109 may include a USB connection unit to which a connection terminal of the USB standard is connected, a parallel interface, and the like. The controller 102 communicates with a user terminal, a USB device, or other external devices via the communication I/F 109.

FIG. 4A is a diagram showing an exemplary pre-approval application form. In the following description, the pre-approval application form is referred to as “application sheet”. The application contents 503 that need the approval of the approver are described in the application sheet. The application sheet includes a seal field 501 for the approver. FIG. 4B is a diagram showing an exemplary approved application form, which is approved for the application sheet (pre-approval application sheet) of FIG. 4A. In the following description, the approved application form is referred to as an approved application sheet. In the application sheet of FIG. 4A, since it is not approved, the seal field 501 is blank. The applicant causes the image forming apparatus 100 to read the application sheet shown in FIG. 4A. When the application contents 503 described in the application sheet are approved, the image forming apparatus 100 outputs the approved application sheet shown in FIG. 4B. A seal 502 of the approver is printed in the seal field 501 of the approved application sheet shown in FIG. 4B.

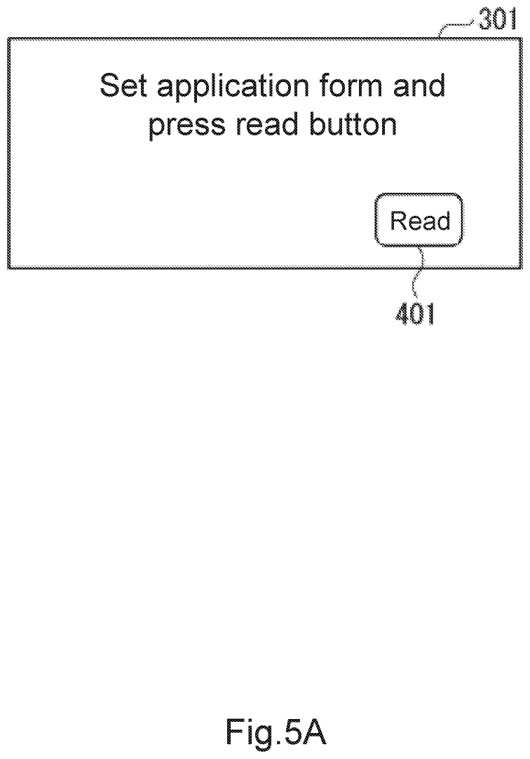

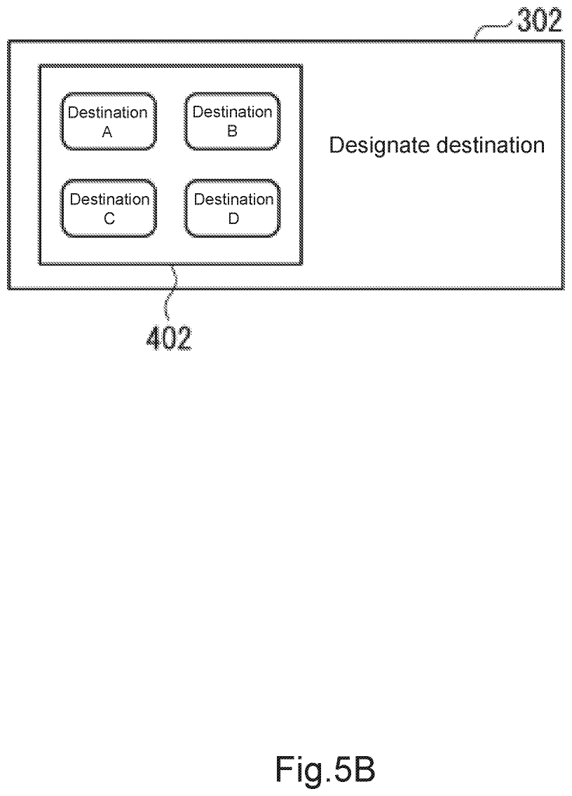

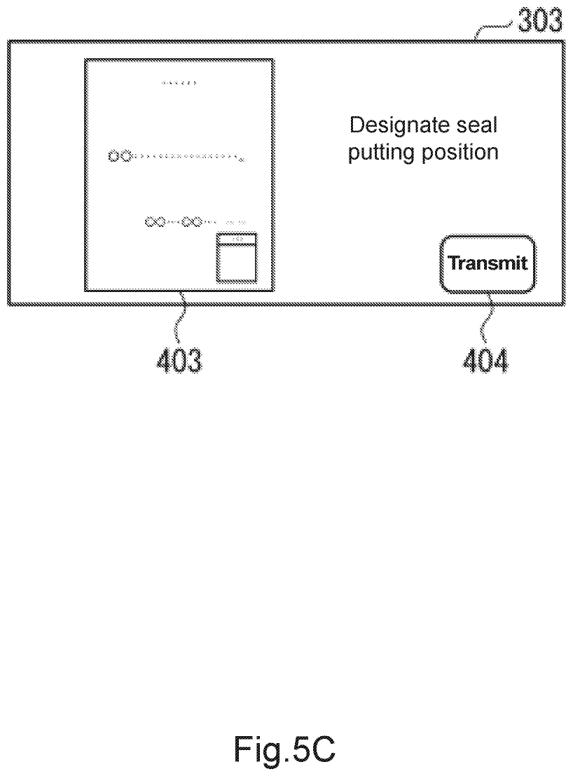

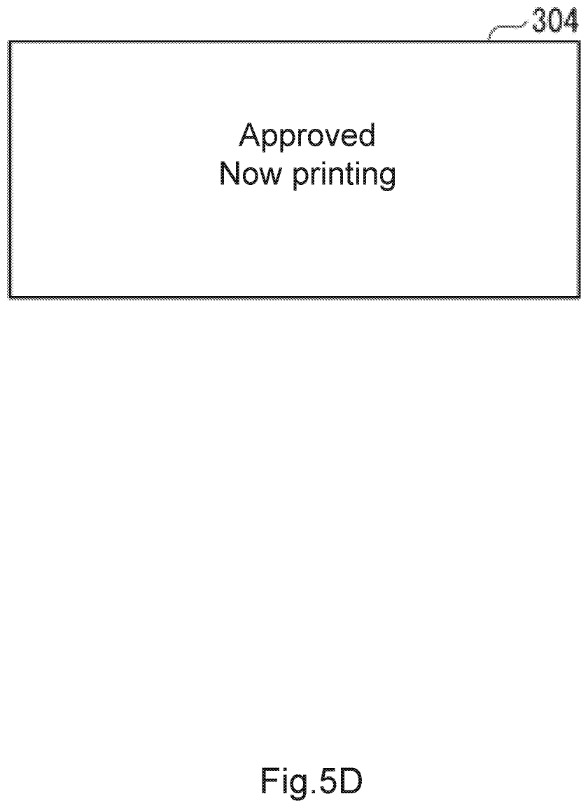

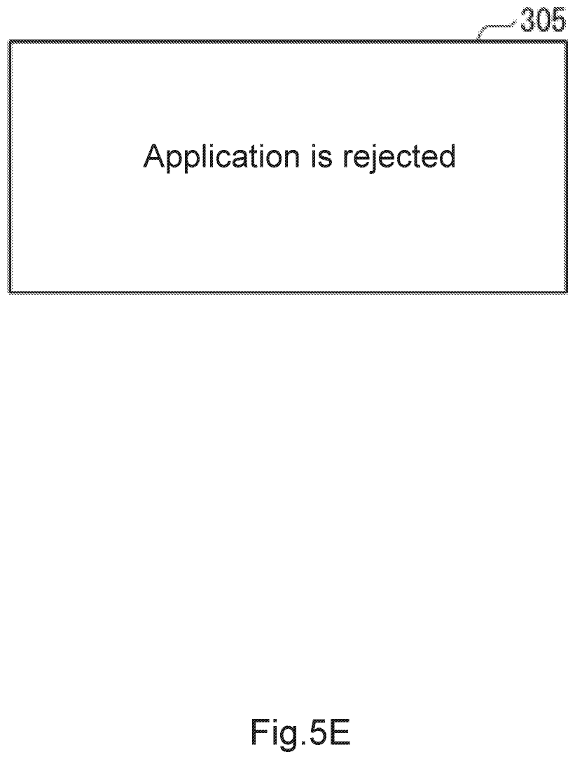

Next, exemplary screens to be displayed on the display 110 will be described with reference to FIGS. 5A to 5E. The controller 102 causes the display 110 to display a screen 301 shown in FIG. 5A in order to read the application sheet (pre-approval application sheet). In the screen 301, a character string, “Set the application form and press the read button.”, and a read button 401 are displayed. The applicant sets the application sheet onto the platen or document feeder (DF) of the image forming apparatus 100 and operates the read button 401. Thus, the controller 102 causes the image reading device 200 to read the application sheet (pre-approval application sheet) and generate application image data indicating the application sheet.

Next, the controller 102 causes the display 110 to display a screen 302 shown in FIG. 5B in order to make the applicant designate an approval destination (approval apparatus 10) to which the generated application image data is to be transmitted. In the screen 302, a character string, “Designate the destination.”, and a destination designating field 402 are displayed. In the destination designating field 402, buttons indicating destinations A, B, C, and D are displayed. The applicant can designate a destination by operating a button corresponding to a desired approval destination. Note that the manner in which the buttons of the destination designating field 402 are displayed is merely an example, and the number of buttons may be three or less or five or more. Further, a destination such as an e-mail address of the approver may be input in text by the applicant using a software keyboard.

Next, the controller 102 causes the display 110 to display a screen 303 for designating a seal putting position. In other words, the controller 102 causes the display 110 to display an image 403 of the application sheet (application sheet before application) indicated by the application image data. The applicant designates an input position of the image 403, at which an authentication image (e.g., the seal 502 shown in FIG. 4B) is to be superimposed. The designating method is a method of touching the input position in the image 403 of the screen 303 with a finger or a stylus pen. The designated input position is also displayed on the approval apparatus 10 such that the approver can recognize the input position. The input position is favorably obvious as in the case of the image 403. Even if the input position is not obvious, the approver can easily recognize the input position.

When the input position is designated and a transmission button 404 is operated, the application image data indicating the application sheet is transmitted to the approval apparatus 10 serving as the approval destination together with the information indicating the designated input position. If the input position is obvious, the application image data may be transmitted without designating the input position. In other words, once the destination is designated in the screen 302, the controller 102 may transmit the application image data to the destination as soon as possible without displaying the screen 303. Further, the input position is referred to as “seal putting position” as an example in FIG. 5C, but the input position may be a “seal affixing position” indicating the position at which a seal is to be affixed, or may be a “signature position” indicating the position at which a signature is to be signed. Besides, the image forming apparatus 100 may automatically determine the input position and designate the determined input position.

The controller 102 determines whether or not the application is approved at the approved destination. The determination method will be described later. If it is determined that the application contents 503 described in the application sheet are approved at the approval destination, the controller 102 causes the display 110 to display a screen 304 shown in FIG. 5D, and causes the printer device 130 to output the approved application sheet indicating that the application contents 503 are approved. A character string “Approved. Now printing.” is displayed in the screen 304. At that time, the sheet to be output is, for example, the approved application sheet (approved application form) shown in FIG. 4B.

On the other hand, if it is determined that the application contents 503 described in the application sheet are rejected at the approved destination, the controller 102 causes the display 110 to display a screen 305 shown in FIG. 5E. A character string “Application is rejected.” is displayed in the screen 305. In this case, the approved application sheet is not output as a matter of course.

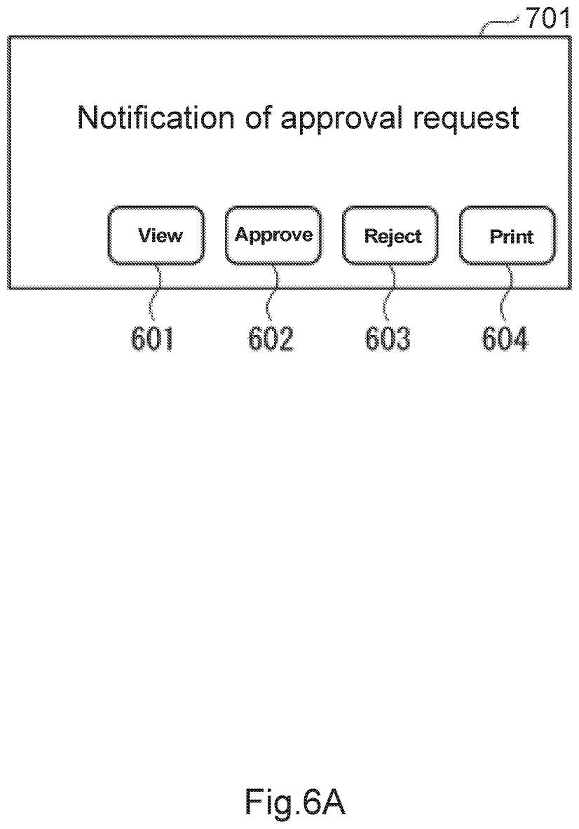

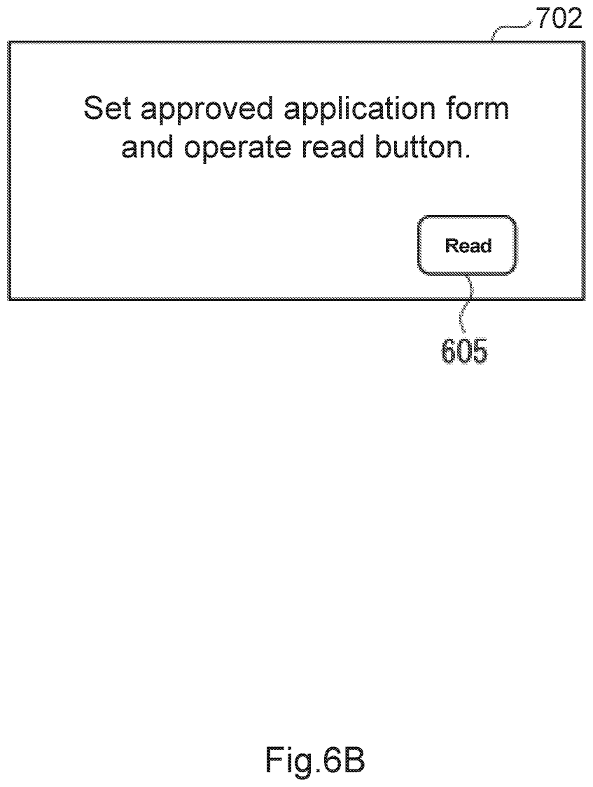

Next, exemplary screens to be displayed on the approval apparatus 10 will be described with reference to FIGS. 6A and 6B. When receiving the application image data as an approval request from the image forming apparatus 100, the approval apparatus 10 displays a screen 701. A view button 601, an approval button 602, a rejection button 603, and a print button 604 are displayed in the screen 701.

The view button 601 is a button for displaying an image indicating the application sheet, which has applied, on the approval apparatus 10. The approval button 602 is a button for approving the application contents 503 described in the application sheet. The rejection button 603 is a button for rejecting the application contents 503. The print button is a button for printing the application sheet, which has applied, by a printer connected to the approval apparatus 10.

When approving the application contents 503 described in the application sheet, the approver operates the approval button 602 or the print button 604 in the screen 701. If the approver presses the approval button 602, authentication image data is transmitted to the image forming apparatus 100 serving as an application source. The authentication image data will be described later. On the other hand, if the approver operates the print button 604, the application sheet (pre-approval application sheet) is printed, and a screen 702 shown in FIG. 6B is displayed on the approval apparatus 10.

A character string, “Set the approved application form and operate the read button.”, and a read button 605 are displayed in the screen 702. The approver puts a seal, affixes a seal, or signs to the printed application sheet. Thus, an approved application sheet is created. The approver sets the approved application sheet onto a reading device such as a scanner connected to the approval apparatus 10. Subsequently, when the approver operates the read button 605 of the screen 702, approved image data obtained by reading the approved application sheet is transmitted to the image forming apparatus 100 serving as the application source. The approved image data will be described later.

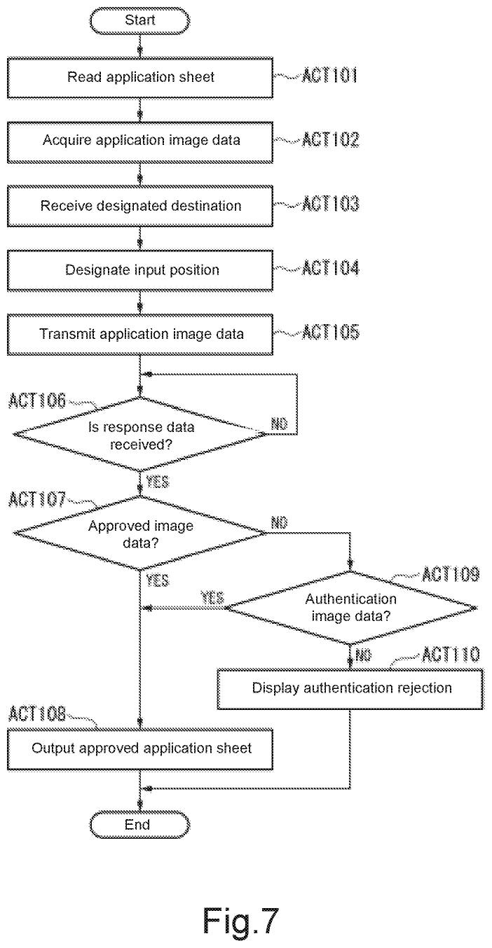

Next, the processing of the image forming apparatus 100 will be described. FIG. 7 is a flowchart showing the processing performed by the controller 102 of the image forming apparatus 100. In ACT101 of FIG. 7, the controller 102 causes the image reading device 200 to read the application sheet (see FIG. 4A) and to generate application image data indicating the application sheet. In ACT102, the controller 102 acquires the application image data indicating the application sheet from the image reading device 200 and stores the application image data in the storage device 108, for example. In ACT103, the controller 102 causes the display 110 to display the screen 302 shown in FIG. 5B in order to make the applicant designate a destination. The controller 102 then receives a destination designated by the applicant in the screen 302. The controller 102 determines the received destination to be an approval apparatus 10 serving as an approval destination (transmission destination) to which the application image data is to be transmitted.

Next, in ACT104, the controller 102 causes the display 110 to display the screen 303 shown in FIG. 5C in order to make the applicant designate a seal putting position. The controller 102 determines the input position designated by the applicant in the screen 303 to be an input position to which an authentication image is to be input by the approver. In ACT105, the controller 102 transmits the application image data together with information indicating the designated input position to the approval apparatus 10 serving as the approval destination.

In ACT106, the controller 102 determines whether or not response data is received from the approval apparatus 10 serving as the approval destination. If response data is received from the approval apparatus 10 serving as the approval destination (ACT106: YES), the processing of the controller 102 proceeds to ACT107. In ACT107, the controller 102 determines whether or not the application is approved at the approved destination on the basis of the received response data. Here, the response data to be received includes three kinds of response data. The first response data is approved image data indicating an application sheet (approved application sheet) on which an authentication image is superimposed, the authentication image indicating that the application is approved at the approved destination. Here, the authentication image is an image indicating that the application contents 503 described in the application sheet are approved. The authentication image is an image of a put seal, an image of an affixed seal, or an image of a signature. The second response data is authentication image data. The approved image data and the authentication image data are data indicating an approval of the application. The third response data is data indicating a rejection of the application.

Of those three pieces of the data, the first approved image data and the second authentication image data will be described.

First, the first approved image data will be described. As described above, the approver prints the application form image data received at the approval apparatus 10. The approver superimposes the authentication image on the printed application sheet. Specifically, for example, the approver puts a seal, affixes a seal, or signs to the application sheet (see FIG. 4A). The approver operates the read button 605 displayed in the screen 702 of FIG. 6B after setting the application sheet, on which the authentication image is superimposed, onto the reading device. This operation of the read button 605 causes the reading device to read the application sheet on which the authentication image is superimposed. The image data generated by such reading is the approved image data. In this case, if the image forming apparatus 100 prints the approved image data received from the approval apparatus 10 serving as the approval destination as it is, the approved application sheet is provided to the applicant.

Next, the second authentication image data will be described. The authentication image data is image data indicating a seal of the approver, image data indicating a signature, or image data indicating both the seal and the signature. The approver transmits the authentication image data from the approval apparatus 10 to the image forming apparatus 100 of the applicant. The image forming apparatus 100 superimposes an authentication image indicated by the authentication image data on the application sheet and prints it, and thus outputs the approved application sheet. Specifically, for example, the image forming apparatus 100 combines application image data stored in the storage device and the authentication image data with each other, and prints out the approved application sheet on the basis of the combined image data.

The description returns to the flowchart of FIG. 7. As described above, in ACT107, the controller 102 determines whether or not the response data is the approved image data. If the response data is the approved image data (ACT107: YES), the processing of the controller 102 proceeds to ACT108. In ACT108, the controller 102 outputs an approved application sheet in which the authentication image indicated by the authentication image data is superimposed on the application sheet. First, if the response data is the approved image data, the authentication image data described above is extracted from the response data (approved image data). The controller 102 then superimposes the authentication image indicated by the extracted authentication image data on the application sheet (see FIG. 4A), and prints out the approved application sheet (see FIG. 4B). Specifically, the controller 102 superimposes the authentication image at the input position designated in ACT104 on the application sheet and prints out the approved application sheet. More specifically, for example, the controller 102 combines the application image data stored in the storage device 108 and the authentication data with each other such that the authentication image is superimposed at the input position of the application sheet, and prints out the approved application sheet on the basis of the combined image data. In such a manner, the controller 102 outputs the approved application sheet and terminates the processing.

If the response data is not the approved image data (ACT107: NO), the processing of the controller 102 proceeds to ACT109. In ACT109, the controller 102 determines whether or not the response data is authentication image data. If the response data is authentication image data (ACT109: YES), the processing of the controller 102 proceeds to ACT108. In ACT108, the controller 102 outputs an approved application sheet in which the authentication image indicated by the authentication image data is superimposed on the application sheet as described above. Here, the response data is the authentication image data. Therefore, the controller 102 superimposes the authentication image indicated by the authentication image data, which is the response data, on the application sheet (see FIG. 4A) and prints out the approved application sheet (see FIG. 4B). Specifically, the controller 102 superimposes the authentication image at the input position designated in ACT104 on the application sheet and prints out the approved application sheet. More specifically, for example, the controller 102 combines the application image data stored in the storage device 108 and the authentication data with each other such that the authentication image is superimposed at the input position of the application sheet, and prints out the approved application sheet on the basis of the combined image data. In such a manner, the controller 102 outputs the approved application sheet and terminates the processing.

On the other hand, if the response data is not the authentication image data (ACT109: NO), the processing of the controller 102 proceeds to ACT110. In ACT110, the controller 102 causes the display 110 to display the screen 305 shown in FIG. 5E and notifies the applicant of the fact that the authentication of the application is rejected. The controller 102 then terminates the processing.

With the image forming apparatus 100 according to the embodiment described above, an image forming apparatus suitable for remote working can be provided.

In the above embodiment, the authentication image data is transmitted from the approval apparatus 10 to the image forming apparatus 100 of an applicant, but the embodiment is not limited thereto. For example, a server that manages authentication image data of a plurality of approvers is set up. The approval apparatus 10 then transmits information merely indicating that an approval is provided, to the image forming apparatus 100. The image forming apparatus 100 that has received the information acquires authentication image data from the above-mentioned server.

Printing out the approved application sheet in ACT108 may be performed using a post-processing apparatus. The post-processing apparatus includes printers with tape cartridges and printers with pigment ink jets. In such a manner, it is possible to perform printing in a mode different from the printing by the image forming apparatus 100 using a normal toner. Further, the post-processing apparatus may be provided with a head of a dot impact printer to print images indicated by the application image data on non-carbon copy paper.

The functions of the image forming apparatus in the embodiment described above may be implemented by a computer. In such a case, those functions may be implemented when a program for implementing such functions is recorded on a computer-readable recording medium, and a computer system reads and then executes the program recorded on the recording medium. Note that the “computer system” used herein includes hardware such as an OS and peripheral devices. Further, the “computer-readable recording medium” refers to a portable medium such as a flexible disk, a magneto-optical disk, a ROM, or a CDROM, or a storage device such as a hard disk incorporated in the computer system. Furthermore, the “computer-readable recording medium” may include a medium that dynamically holds a program for a short period of time, like a communication line for transmitting a program through a network such as the Internet or a communication line such as a telephone line, and a medium that holds a program for a certain period of time, like a volatile memory inside a computer system serving as a server or a client in the former case. Further, the above-mentioned program may be a program for implementing a part of the above-mentioned functions, or may be a program that can be implemented by combining the above-mentioned functions with a program already recorded in the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, which outputs an approved application sheet for an application sheet of an applicant, application contents that need an approval of an approver being described in the application sheet, the approved application sheet indicating that the approver has approved the application contents, the image forming apparatus comprising:
a communication interface that transmits and receives data to and from one or more approval apparatuses to be operated by the approver to approve the application contents described in the application sheet;
an image reading device that reads the application sheet;
a printer device that prints out the approved application sheet; and
a controller configured to
cause the image reading device to read the application sheet and generate image data indicating the read application sheet,
transmit the generated image data to one approval apparatus of the one or more approval apparatuses via the communication interface,
receive response data for the transmitted image data from the one approval apparatus via the communication interface,
determine whether or not the application contents described in the application sheet are approved on a basis of the response data, and
cause the printer device to print out the approved application sheet for the application sheet if it is determined that the application contents described in the application sheet are approved.

2. The image forming apparatus according to claim 1, wherein
the controller determines that the application contents described in the application sheet are approved if the response data received from the one approval apparatus is approved image data, and
the approved image data is image data indicating the approved application sheet on which an authentication image is superimposed, the authentication image indicating that that the application contents described in the application sheet are approved.

3. The image forming apparatus according to claim 2, wherein
the authentication image includes an image of a seal of the approver or an image of a signature of the approver, and
the application sheet on which the authentication image is superimposed is an application sheet to which a seal is put, a seal is affixed, or a signature is signed by the approver.

4. The image forming apparatus according to claim 2, wherein
the controller
extracts image data indicating the authentication image from the received approved image data, and
causes the printer device to superimpose the authentication image indicated by the extracted image data on the application sheet and print the application sheet, to output the approved application sheet.

5. The image forming apparatus according to claim 2, wherein
the controller
extracts image data indicating the authentication image from the received approved image data,
combines the extracted image data indicating the authentication image and the generated image data indicating the application sheet with each other, and
causes the printer device to print out the approved application sheet on a basis of the combined image data.

6. The image forming apparatus according to claim 1, wherein
the controller determines that the application contents described in the application sheet are approved if the response data received from the one approval apparatus is authentication image data, and
the authentication image data is image data indicating that the application contents described in the application sheet are approved.

7. The image forming apparatus according to claim 6, wherein
the controller causes the printer device to superimpose an authentication image indicated by the authentication image data on the application sheet and print the application sheet, to output the approved application sheet in which the authentication image is printed.

8. The image forming apparatus according to claim 6, wherein
the controller
combines the authentication image data and the generated image data indicating an image of the application sheet with each other, and
causes the printer device to print out the approved application sheet on a basis of the combined image data.

9. The image forming apparatus according to claim 3, wherein
the authentication image is the image of the seal of the approver or the image of the signature of the approver.

10. A method of controlling an image forming apparatus, which outputs an approved application sheet for an application sheet of an applicant, application contents that need an approval of an approver being described in the application sheet, the approved application sheet indicating that the approver has approved the application contents, the method comprising:
causing an image reading device to read the application sheet and generate image data indicating the read application sheet;
transmitting the generated image data to one approval apparatus of one or more approval apparatuses to be operated by the approver to approve the application contents described in the application sheet;
receiving response data for the transmitted image data from the one approval apparatus via a communication interface;
determining whether or not the application contents described in the application sheet are approved on a basis of the response data; and
causing a printer device to print out the approved application sheet for the application sheet if it is determined that the application contents described in the application sheet are approved.
